(19) United States
(12) Patent Application Publication
(10) Pub. No.: US 2026/0186849 A1
(43) Pub. Date: Jul. 2, 2026

(54) PRECISE DESTINATION-BASED REQUEST THROTTLING

(71) Applicant: Ampere Computing LLC, Santa Clara, CA (US)

(72) Inventors: Sumiran SHUHBHI, Santa Clara, CA (US); Matthew Robert ERLER, Portland, OR (US); Raymond Scott TETRICK, Portland, OR (US)

(21) Appl. No.: 19/007,336

(22) Filed: Dec. 31, 2024

(51) Int. Cl. G06F 9/50; G06F 9/48

(52) U.S. Cl. CPC G06F 9/505; G06F 9/4881; G06F 2209/485

(57) ABSTRACT

Disclosed are techniques for destination-based request throttling. In an aspect, a method for destination-based request throttling may include determining whether to adjust, based on a request-handling capacity and a busyness value associated with at least one completer of a plurality of completers, a request handling rate of the at least one completer of the plurality of completers.

### BACKGROUND

### I. Field of the Disclosure

Aspects of the disclosure relate generally to management of request rates to components based on workload and processing capabilities.

### II. Background

Chiplets, which may be described as modular chips that perform a specified function, may be utilized in System-on-Chip (SoC) architectures. In one type of application, an Inter-Chiplet Transport Agent (ITA) protocol may function as a proxy for inter-chiplet communication. Specifically, the ITA may function as a proxy for requestors on a source chiplet. As a single node, the ITA may direct requests to multiple destination completers such as Coherent Home Agent (CHA), peripheral component interconnect express (PCIe) Home Agent (PHA), Compute Express Link (CXL) Controller, and Inter-Socket Gateway (ISG).

The busyness of these completers may vary depending on the workload. Known solutions include drawbacks in that they do not accurately account for the busyness, such as a current number of requests being handled, of the completers. Known solutions also do not accurately account for request-handling capacities, such as track depth and other such parameters, of different completers. Thus, there is a need for a solution that accurately accounts for the busyness and the request-handling capacities of different completers, to thus allow traffic to flow through in the case of skewed request rates to different completers.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

According to examples disclosed herein, a method for destination-based request throttling may include determining whether to adjust, based on a request-handling capacity and a busyness value associated with at least one completer of a plurality of completers, a request handling rate of the at least one completer of the plurality of completers.

According to further examples disclosed herein, an apparatus for destination-based request throttling may include a requestor comprising a request-handling capacity analysis circuit configured to analyze a request-handling capacity associated with at least one completer of a plurality of completers. A busyness tracking circuit may be configured to determine a busyness value associated with the at least one completer of the plurality of completers. Further, a comparison circuit may be configured to determine whether to adjust, based on the request-handling capacity and the busyness value associated with the at least one completer of the plurality of completers, a request handling rate of the at least one completer of the plurality of completers.

According to examples disclosed herein, an apparatus for destination-based request throttling may include means for determining whether to adjust, based on a request-handling capacity and a busyness value associated with at least one completer of a plurality of completers, a request handling rate of the at least one completer of the plurality of completers.

According to examples disclosed herein, a non-transitory computer-readable medium may store computer-executable instructions that, when executed by a processor, cause the processor to determine whether to adjust, based on a request-handling capacity and a busyness value associated with at least one completer of a plurality of completers, a request handling rate of the at least one completer of the plurality of completers.

Other objects and advantages associated with the aspects disclosed herein will be apparent to those skilled in the art based on the accompanying drawings and detailed description.

For the apparatuses and methods disclosed herein, the elements of the apparatuses and methods disclosed herein may be any combination of hardware and programming to implement the functionalities of the respective elements. In some examples described herein, the combinations of hardware and programming may be implemented in a number of different ways. For example, the programming for the elements may be processor executable instructions stored on a non-transitory machine-readable storage medium and the hardware for the elements may include a processing resource to execute those instructions. In these examples, a computing device implementing such elements may include the machine-readable storage medium storing the instructions and the processing resource to execute the instructions, or the machine-readable storage medium may be separately stored and accessible by the computing device and the processing resource. In some examples, some elements may be implemented in circuitry.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example architectural block diagram of a destination-based request throttling apparatus, in accordance with an example of the present disclosure;

FIG. 2 illustrates a block diagram of a many-core system on a chip (SoC) that supports performing destination-based request throttling, in accordance with an example of the present disclosure; and

FIG. 3 illustrates a flowchart of an example process for destination-based request throttling, in accordance with an example of the present disclosure.

### DETAILED DESCRIPTION

Disclosed herein are apparatuses and methods for destination-based request throttling. Throttling may be described as controlling, for example, by limiting, a request rate of requests sent from a requestor to a completer. Requestors, as disclosed herein, may include any types of clients, applications, and other such elements, and completers, as disclosed herein, may include any type of component or resource that is utilized to perform a request.

The apparatuses and methods may utilize a completer busy (CBusy) indication in CHI response packets. The CBusy indication may be used to convey information about the busyness of a node, such as a completer node, to a requestor. In this regard, a requestor node may track the busyness of each individual destination (e.g., each individual completer) using accumulators and thresholds, and adjust a request rate of the requestor node to the corresponding destination node accordingly.

With respect to destination-based request throttling generally, as disclosed herein, the ITA protocol may function as a proxy for inter-chiplet communication, for example, as a proxy for requestors on a source chiplet. As a single node, the ITA may direct requests to multiple destination completers such as CHA, PHA, CXL, and ISG. In this regard, the busyness of these completers may vary depending on the workload. The apparatuses and methods disclosed herein account for this busyness on a per-device basis to allow miscellaneous traffic to flow through in the case of skewed request rates to different completers. Miscellaneous traffic may be described as any traffic that does not need to be throttled. A skewed request rate may be described as the request rate to one completer or one type of completer being different (e.g., higher) than other completers. The apparatuses and methods also provide for mitigation of the impact of unique request-handling capacities of each type of completer. In this regard, each completer may be individually identified based on their destination identification (ID). A comparator, as disclosed herein, may compare values of busyness associated with individual completers with one or more specified thresholds to thereby throttle requests to one or more completers depending on their individual busyness. Thus instead of throttling requests to completers that may not be busy, throttling of requests is limited to busy completers.

The apparatuses and methods disclosed herein account for busyness on a per-device basis to allow miscellaneous traffic to flow through to mitigate the impact of unique request-handling capacities of each type of completer. In this regard, an example of a unique request-handling capacity of a completer may include a track depth associated with a completer. The track depth may correspond to a number of requests that can be accepted by a completer from a requestor until the completer is considered busy. For example, completers may include track depths of 64, 256, etc. The thresholds as disclosed herein may be tuned to align to the request-handling capacity of each completer. For example, a threshold for a completer including a track depth of 64 may be specified at 60, whereas a threshold for a completer including a track depth of 256 may be specified at 242. In another example, the thresholds as disclosed herein may be tuned based on a ratio of requests to completer capacity to align to the request-handling capacity of each completer.

According to another example, if the core to remote chiplet double data rate (DDR) memory traffic is high, remote CHA queues may be full, which may cause the ITA to throttle its requests. Due to this, the remote peer-to-peer (P2P) request rate may decrease, and P2P performance may be diminished even though the target PHA can service a higher request rate. The apparatuses and methods disclosed herein address such performance issues by efficiently pipelining evaluation of requests. In this regard, the evaluation of whether requests are ready to be scheduled may be executed independently from request scheduling so that the scheduling of requests is not slowed down, and a dispatcher queue may be sized accordingly. Yet further, the apparatuses and methods disclosed herein address such performance issues by utilizing custom accumulator thresholds depending on queue size or capacity of different types of nodes.

According to examples of the apparatuses and methods disclosed herein, the throttling may enable scaling for mixed workloads being performed on a SoC. For example, the mechanism the throttling as disclosed herein may enable scaling for workloads that are a mix of CXL memory accesses along with DDR memory accesses, P2P traffic and local DDR memory traffic, and accesses to local and remote (2P) DDR memory.

According to examples of the apparatuses and methods disclosed herein, by customizing accumulator thresholds for different completers, traffic may be prioritized as needed. For example, lower accumulator thresholds may be utilized for CXL memory traffic or 2P traffic, whereas higher accumulator thresholds may be utilized for local DDR memory traffic. In this regard, for the higher accumulator thresholds, the requestor (e.g., a core) may throttle at a higher percentage of requests (e.g., throttle later), compared to lower accumulator thresholds.

According to examples of the apparatuses and methods disclosed herein, for a requestor that interacts with multiple completers and includes a CBusy-throttling mechanism enabled, the requestor may initiate throttling to align with the resource of the least capacity.

According to examples of the apparatuses and methods disclosed herein, for a requestor that includes a CBusy-throttling mechanism enabled, a total system bandwidth may be represented as a sum of individual bandwidths associated with the requestor. Further, for a requestor that does not include the CBusy-throttling mechanism enabled, a total system bandwidth may be represented as a minimum bandwidth associated with the requestor. For example, assuming that for a CXL memory controller and a DDR memory controller, the CXL memory controller is saturated by running bandwidth tests from a requestor, where the bandwidth observed is BW_{CXL}, and the then DDR memory controller is saturated by running bandwidth tests from a requestor, where the bandwidth observed be BW_{DDR}, when the bandwidth traffic is run together from the requestor that includes a CBusy-throttling mechanism enabled, the combined observed bandwidth may be represented as BW_{Comb}, where BW_{Comb}˜=BW_{DDR}+BW_{CXL}. Further, for a requestor that does not include the CBusy-throttling mechanism enabled, when the bandwidth traffic is run together from the requestor, the combined observed may be represented as BW_{Comb}, where BW_{Comb}˜=Min(BW_{DDR}, BW_{CXL}).

According to examples of the apparatuses and methods disclosed herein, the apparatuses and methods may be implemented in SoC and other such environments.

According to examples of the apparatuses and methods disclosed herein, a requestor node may track the busyness of each individual destination using accumulators and thresholds, and adjust a request rate of the requestor node to the corresponding destination node accordingly. In this regard, the busyness of each individual destination may be analyzed in independently with request scheduling.

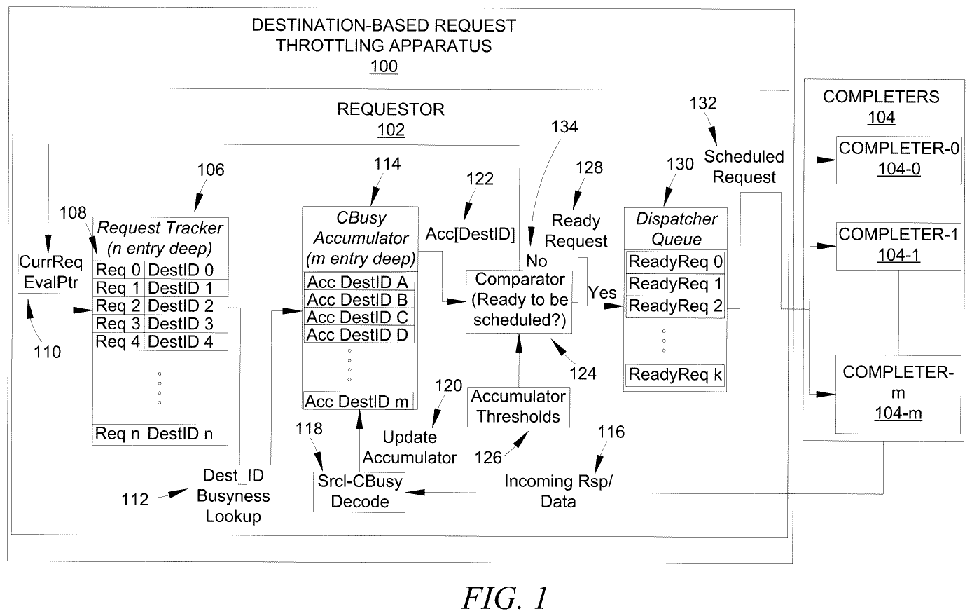

FIG. 1 illustrates an example architectural block diagram of a destination-based request throttling apparatus (hereinafter also referred to as “apparatus 100”), in accordance with an example of the present disclosure.

Referring to FIG. 1, a requestor 102 may analyze (e.g., by a request-handling capacity analysis circuit) request-handling capacities of a plurality of completers 104 (e.g., completer-0, completer-1, . . . , completer-m; also respectively designated 104-0, 104-1, . . . , 104-m). For example, the requestor 102 may analyze, based on destination identifications (IDs) of the plurality of completers 104, the request-handling capacities of the plurality of completers 104. Examples of request-handling capacities may include track depth and other such parameters for the completers 104. A request tracker 106, the operation of which is described in further detail below, may include destination IDs for the completers 104, such as “DestID 0”, “DestID 1”, . . . , “DestID m”.

The requestor 102 may analyze (e.g., by a busyness tracking circuit) busyness values associated with the plurality of completers 104. For example, the requestor 102 may analyze completer busy (CBusy) indications in CHI response packets as indications of the busyness values associated with the plurality of completers 104. A CBusy accumulator 114, the operation of which is described in further detail below, may account for the CBusy indications.

The requestor 102 may determine (e.g., by a threshold determination circuit), based on the request-handling capacities of the plurality of completers 104 and the busyness values associated with the plurality of completers 104, a threshold associated with each completer of the plurality of completers 104. Thresholds associated with the plurality of completers 104 may be stored as accumulator thresholds 126, which are described in further detail below.

The requestor 102 may compare (e.g., by a comparison circuit) the busyness value associated with the at least one completer of the plurality of completers 104 to a corresponding threshold associated with the at least one completer of the plurality of completers 104. In this regard, a comparator 124, the operation of which is described in further detail below, may compare the busyness value associated with the at least one completer of the plurality of completers 104 to a corresponding threshold associated with the at least one completer of the plurality of completers 104.

The requestor 102 may determine whether to throttle (e.g., by the comparison circuit), based on the request-handling capacity and the comparison of the busyness value associated with the at least one completer of the plurality of completers 104 to the corresponding threshold associated with the at least one completer of the plurality of completers 104, by the at least one request that is to be handled by the at least one completer of the plurality of completers 104. In this regard, if a determination is made to throttle, as described in further detail below, the at least one request that is to be handled by the at least one completer of the plurality of completers 104 may be re-analyzed as to whether the at least one request can be handled by the at least one completer of the plurality of completers 104. In this regard, if an accumulator value for a completer is greater than the completer's threshold, the requestor 102 may choose not to send out that request. In the example of FIG. 1, an accumulator value may represent added values of a CBusy field received from each incoming response/data field 116 received from a completer. If the requestor 102 chooses not to send out that request, the requestor 102 may instead put the request back in the request tracker 106 to be re-evaluated for dispatch at a later time. Next, with respect to the determination of whether to throttle, if a determination is made not to throttle, as described in further detail below, the at least one request that is to be handled by the at least one completer of the plurality of completers 104 may be scheduled for handling by the at least one completer of the plurality of completers 104.

In another aspect, the requestor 102 may determine whether to adjust (e.g., by the comparison circuit), based on a request-handling capacity and a busyness value associated with at least one completer of a plurality of completers 104, a request handling rate of the at least one completer of the plurality of completers 104. In this regard, compared to throttling by at least one request, adjusting the request handling rate may include increasing or decreasing the request handling rate. Adjusting, as disclosed herein, may encompass throttling, which may be described as controlling, for example, by limiting, a request rate of requests sent from a requestor to a completer. For example, the throttling may include limiting by at least one request that is to be handled by the at least one completer of the plurality of completers.

Components and operation of the requestor 102 are described in further detail with continued reference to FIG. 1.

The requestor 102 may include the request tracker 106 that includes a queue of requests 108. The queue may include a list of the requests 108, such as “Req 0”, “Req 1”, . . . , “Req n”, and a destination ID, such as “DestID 0”, “DestID 1”, . . . , “DestID m”, associated with each completer of the plurality of completers 104.

A current request evaluation pointer 110 (e.g., “CurrReqEvalPtr”) may point to a request (e.g., “Req 2” as shown) that is to be scheduled for processing. In the example shown, the “Req 2” may correspond to the completer-2 (e.g., completer 104-2) including “DestID 2”.

A destination ID busyness lookup instruction 112 may be sent to the CBusy accumulator 114 to determine whether the request (e.g., “Req 2” as shown) can be performed.

The CBusy accumulator 114 may store an accumulator value for each of the completers 104. For example, the CBusy accumulator 114 may store the accumulator value “Acc DestID A” for completer-0 (e.g., completer 104-0), “Acc DestID B” for completer-1 (e.g., completer 104-1), etc. An accumulator value may represent added values of a CBusy field received from each incoming response/data field 116 received from a completer.

The incoming response/data field 116 may be decoded by a source-ID-CBusy decoder 118 (e.g., “SrcID-CBusy Decode”) to determine a source ID of a response, which corresponds to a destination ID for the requestor 102.

An accumulator update instruction 120 may be sent to the CBusy accumulator 114, where an accumulator value corresponding to the determined source ID may be updated. For example, busyness information, which in the form of an encoded value, may be returned to the requestor 102 in a response packet sent by a completer. This encoded value may be used to update the CBusy accumulator 114, where the encoded value, once decoded, may be added to or subtracted from the accumulator value.

The updated accumulator value corresponding to the destination ID specified for the destination ID busyness lookup instruction 112 may be compared by the comparator 124 to a threshold received from the accumulator thresholds 126. For the example shown, the threshold received from the accumulator thresholds 126 may correspond to the threshold specified for completer-2 (e.g., completer 104-2) corresponding to “DestID 2”.

The accumulator thresholds 126 may utilize custom accumulator thresholds depending on queue size or capacity of different types of completers. By customizing accumulator thresholds for different completers, traffic may be prioritized as needed. For example, lower accumulator thresholds may be utilized for CXL memory traffic or 2P traffic, whereas higher accumulator thresholds may be utilized for local DDR memory traffic. A granularity of the accumulator thresholds to completers may be 1:1. For example, a number of accumulator thresholds may be the same as a number of completers that a requestor is tracking (e.g., same as depth of the CBusy accumulator 114 in FIG. 1, e.g., m).

With respect to comparison of the updated accumulator value for the destination ID to a threshold received from the accumulator thresholds 126, if a result of the comparison is “yes” at 128 (e.g., the updated accumulator value is less than or equal to a threshold of busyness), then the request (e.g., “Req 2” as shown) may be ready to be scheduled by being placed in a dispatcher queue 130 and scheduled at 132 at a next instance.

The dispatcher queue 130 may provide for efficient pipelining evaluation of requests. In this regard, the evaluation of whether requests are ready to be scheduled (e.g., by the comparator 124) may be executed independently from request scheduling (e.g., by a request scheduling circuit that controls the dispatcher queue 130) so that the scheduling of requests is not slowed down, and the dispatcher queue 130 may be sized accordingly.

If a result of the comparison is “no” at 134 (e.g., the updated accumulator value is greater than the threshold of busyness), then the request (e.g., “Req 2” as shown) may be returned to the current request evaluation pointer 110. Thus, the request (e.g., “Req 2” as shown) may be re-evaluated for scheduling at a later time. With respect to re-evaluation of requests, a valid bit may be associated with each tracker entry to loop back to. Additionally, logic, such as the current request evaluation pointer 110, may store a tracker entry index and associated destination ID of evaluated requests that were not sent out. This may allow the current request evaluation pointer 110 to loop back to these requests that need to be re-evaluated. This structure may also facilitate moving on to a different destination ID, if the destination of the currently-evaluated request has indicated that its destination (e.g., a completer) is busy (e.g., accumulator value>threshold).

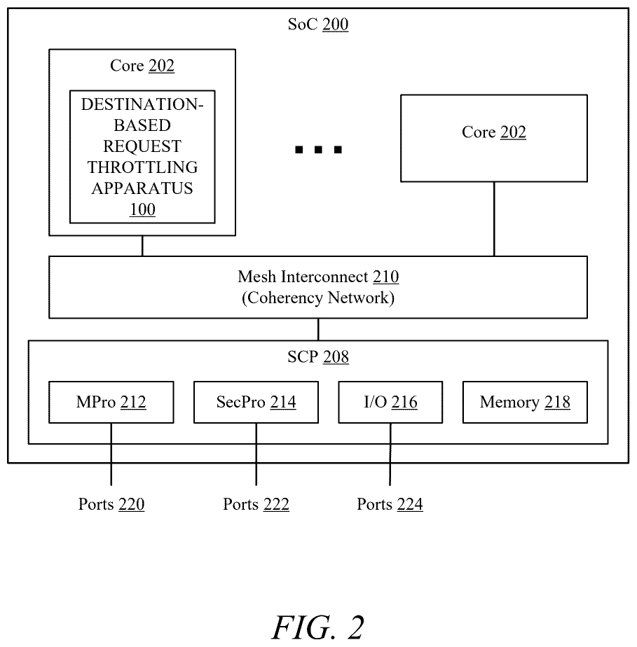

FIG. 2 illustrates a block diagram of a many-core system on a chip (SoC) that supports performing destination-based request throttling, in accordance with an example of the present disclosure.

The SoC 200 illustrated in FIG. 2 includes a set of processing cores 202 (or simply “cores” 202). In the example illustrated in FIG. 2, one or more of the cores 202, and/or further elements disclosed herein with respect to SoC 200 may implement the apparatus 100. Additionally, the requestor 102 may include, for example, I/O requestor agents.

The SoC 200 also includes a system control processor (SCP) 208 that handles many of the system management functions of the SoC 200. The cores 202 may be connected to the SCP 208 via a mesh interconnect 210 that forms a high-speed bus that couples each of the cores 202 to the other cores 202 and to other on chip and off-chip resources, including higher levels of memory (e.g., a level three (L4) cache, dual data rate (DDR) memory), PCIe interfaces, and/or other resources.

The SCP 208 may include a variety of system management functions, which may be divided across multiple functional blocks, or which may be contained in a single functional block. In the example illustrated in FIG. 2, the system management functions of the SCP 208 are divided over a management processor (MPro) 212 and a security processor (SecPro) 214 coupled to other components of the SoC 200 by the mesh interconnect 210. The SoC 200, the MPro 212, and the SecPro 214 may each include joint test action group (JTAG) ports and firmware, which may be connected to other components within the SoC 200 via the mesh interconnect 210, an inter-integrated circuit (I2C) interface, or other connection. In the example illustrated in FIG. 2, the SCP 208 further includes an input/output (I/O) block 216 and an on-board shared memory 218 also coupled to other components of the SoC 200 by the mesh interconnect 210. Note that although FIG. 2 illustrates the MPro 212 and the SecPro 214 as separate microcontrollers (or processors), as will be appreciated, they may be combined into one or two microcontrollers, or sub-divided into more than two microcontrollers.

The MPro 212 and the SecPro 214 may include a bootstrap controller and an I2C controller or other bus controller. The MPro 212 and the SecPro 214 may communicate with on-chip sensors, an off-chip baseboard management controller (BMC), and/or other external systems to provide control signals to external systems. The MPro 212 and the SecPro 214 may connect to one or more off-chip systems as well via ports 220 and ports 222, respectively, and/or may connect to off-chip systems via the I/O block 216, e.g., via ports 224.

The MPro 212 performs error handling and crash recovery for the cores 202 of the SoC 200 and performs power failure detection, recovery, and other fail safes for the SoC 200. The MPro 212 performs the power management for the SoC 200 and may connect to one or more voltage regulators (VR) that provide power to the SoC 200. The MPro 212 may receive voltage readings, power readings, and/or thermal readings and may generate control signals (e.g., dynamic voltage and frequency scaling (DVFS)) to be sent to the voltage regulators. The MPro 212 may also report power conditions and throttling to an operating system (OS) or hypervisor running on the SoC 200. The MPro 212 may provide the power for boot up and may have specific power throttling and specific power connections for boot power to the SCP 208 and/or the SecPro 214. The MPro 212 may receive power or control signals, voltage ramp signals, and other power control from other components of the SCP 208, such as the SecPro 214, during boot up as hardware and firmware become activated on the SoC 200. These power-up processes and power sequencing may be automatic or may be linked to events occurring at or detected by the MPro 212 and/or the SecPro 214. The MPro 212 may connect to the shared memory 218, the SecPro 214, and external systems (e.g., VRs) via ports 220, and may supply power to each via power lines. In some aspects, the MPro 212 is the entity on which firmware resides.

The SecPro 214 manages the boot process and may include on-board read-only memory (ROM) or erasable programmable ROM (EPROM) for safely storing firmware for controlling and performing the boot process. The SecPro 214 also performs security sensitive operations and runs authenticated firmware. More specifically, the components of the SoC 200 may be divided into trusted components and non-trusted components, where the trusted components may be verified by certificates in the case of software and firmware components, or may be pure hardware components, so that at boot time, the SecPro 214 may ensure that the boot process is secure.

The shared memory 218 may be on-board random-access memory (RAM) or secured RAM that can be trusted by the SecPro 214 after an integrity check or certificate check. The I/O block 216 may connect over ports 224 to external systems and memory (not shown) and connect to the shared memory 218. The SCP 208 may use the I/O connections of the I/O block 216 to interface with a BMC or other management system(s) for the SoC 200 and/or to the network of the cloud platform (e.g., via gigabit ethernet, PCIe, or fiber). The SCP 208 may perform scaling, balancing, throttling, and other control processes to manage the cores 202, associated memory controllers, and mesh interconnect 210 of the SoC 200.

In some aspects, the mesh interconnect 210 is part of a coherency network. There are points of coherency somewhere in the mesh network depending on the address and target memory. A coherency network typically includes control registers, status registers, and state machines, and in the example illustrated in FIG. 2, these are initialized by the MPro 212, e.g., based on system and memory configuration, and the MPro 212 monitors the coherency domain for errors.

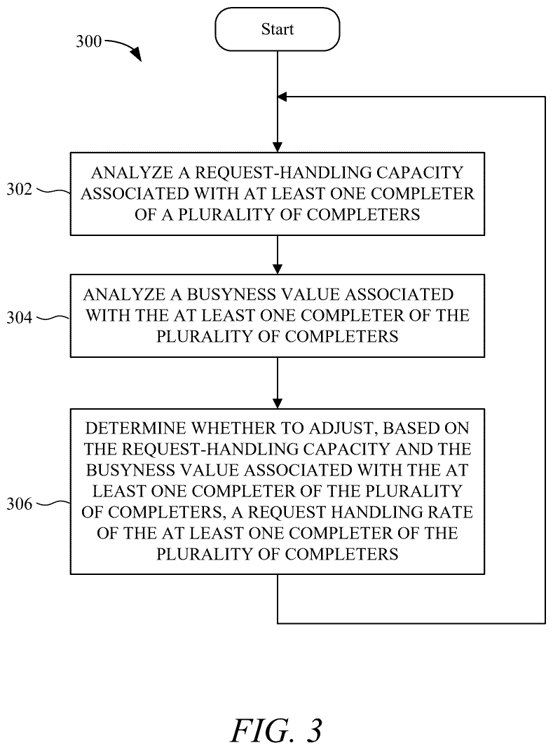

FIG. 3 illustrates a flowchart of an example process 300 associated with destination-based request throttling, in accordance with an example of the present disclosure. In some implementations, one or more process blocks of FIG. 3 may be performed by one or more components of an SoC, such as processor(s), memory, or other circuitry, any or all of which may be means for performing the operations of process 300. As shown in FIG. 3, process 300 may periodically perform an operation configuration. In the example shown in FIG. 3, an operation configuration includes the following steps.

Process 300 may optionally include, at block 302, analyzing (e.g., by a request-handling capacity analysis circuit) a request-handling capacity associated with at least one completer of a plurality of completers 104. In some aspects, analyzing the request-handling capacity associated with the at least one completer of the plurality of completers 104 may further include analyzing, based on destination identifications (IDs) of the plurality of completers 104, the request-handling capacity associated with the at least one completer of the plurality of completers 104. In this regard, an example of a unique request-handling capacity of a completer may include a track depth or other types of parameters associated with a completer. As disclosed herein with respect to FIG. 1, the apparatus 100 may analyze (e.g., by a request-handling capacity analysis circuit) request-handling capacities of a plurality of completers 104 (e.g., completer-0, completer-1, . . . , completer-m; also respectively designated 104-0, 104-1, . . . , 104-m). For example, the requestor 102 may analyze, based on destination IDs of the plurality of completers 104, the request-handling capacities of the plurality of completers 104.

Process 300 may further optionally include, at block 304, analyzing (e.g., by a busyness tracking circuit) a busyness value associated with the at least one completer of the plurality of completers 104. In some aspects, analyzing the busyness value associated with the at least one completer of the plurality of completers 104 may further include analyzing completer busy (CBusy) indications in CHI response packets as indications of the busyness value associated with the at least one completer of the plurality of completers 104. In this regard, the CBusy accumulator 114 may account for the CBusy indications. As disclosed herein, the busyness of a completer may represent a current number of requests being handled by a completer. Further, as disclosed herein with respect to FIG. 1, the apparatus 100 may analyze (e.g., by a busyness tracking circuit) busyness values associated with the plurality of completers 104.

Process 300 may include, at block 306, determining whether to adjust (e.g., by the comparison circuit), based on the request-handling capacity and the busyness value associated with the at least one completer of the plurality of completers 104, a request handling rate of the at least one completer of the plurality of completers 104. In some aspects, as disclosed herein with respect to FIG. 1, determining whether to adjust, based on the request-handling capacity and the busyness value associated with the at least one completer of the plurality of completers 104, the request handling rate of the at least one completer of the plurality of completers 104 may further include determining whether to throttle, based on the request-handling capacity and the busyness value associated with the at least one completer of the plurality of completers 104, by at least one request that is to be handled by the at least one completer of the plurality of completers 104. In this regard, compared to throttling by at least one request, adjusting the request handling rate may include increasing or decreasing the request handling rate. Adjusting, as disclosed herein, may encompass throttling, which may be described as controlling, for example, by limiting, a request rate of requests sent from a requestor to a completer. For example, the throttling may include limiting by at least one request that is to be handled by the at least one completer of the plurality of completers. In other aspects, determining whether to adjust, based on the request-handling capacity and the busyness value associated with the at least one completer of the plurality of completers 104, the request handling rate of the at least one completer of the plurality of completers 104 may further include comparing the busyness value associated with the at least one completer of the plurality of completers 104 to a corresponding threshold (e.g., from the accumulator thresholds 126) associated with the at least one completer of the plurality of completers 104, and determining whether to adjust (e.g., by the comparison circuit), based on the request-handling capacity and the comparison of the busyness value associated with the at least one completer of the plurality of completers 104 to the corresponding threshold associated with the at least one completer of the plurality of completers 104, the request handling rate of the at least one completer of the plurality of completers 104.

Process 300 may include additional implementations, such as any single implementation or any combination of implementations described in connection with one or more other processes described elsewhere herein. Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects). Furthermore, it is also intended that aspects of a clause can be included in any other independent clause, even if the clause is not directly dependent on the independent clause.

It will be understood that the specific implementations described herein are illustrative and not limiting. The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art.

Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art will further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application-specific integrated circuit (ASIC), a field-programmable gate array (FPGA), or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method for destination-based request throttling, the method comprising:
determining whether to adjust, based on a request-handling capacity and a busyness value associated with at least one completer of a plurality of completers, a request handling rate of the at least one completer of the plurality of completers.

2. The method of claim 1, wherein determining whether to adjust, based on the request-handling capacity and the busyness value associated with the at least one completer of the plurality of completers, the request handling rate of the at least one completer of the plurality of completers further comprises:
determining whether to throttle, based on the request-handling capacity and the busyness value associated with the at least one completer of the plurality of completers, by at least one request that is to be handled by the at least one completer of the plurality of completers.

3. The method of claim 1, further comprising:
analyzing completer busy (CBusy) indications in CHI response packets as indications of the busyness value associated with the at least one completer of the plurality of completers.

4. The method of claim 1, further comprising:
determining, based on request-handling capacities associated with the plurality of completers, a threshold associated with each completer of the plurality of completers.

5. The method of claim 1, further comprising:
determining, based on request-handling capacities and busyness values associated with the plurality of completers, a threshold associated with each completer of the plurality of completers.

6. The method of claim 1, wherein determining whether to adjust, based on the request-handling capacity and the busyness value associated with the at least one completer of the plurality of completers, the request handling rate of the at least one completer of the plurality of completers further comprises:
comparing the busyness value associated with the at least one completer of the plurality of completers to a corresponding threshold associated with the at least one completer of the plurality of completers; and
determining whether to adjust, based on the request-handling capacity and the comparison of the busyness value associated with the at least one completer of the plurality of completers to the corresponding threshold associated with the at least one completer of the plurality of completers, the request handling rate of the at least one completer of the plurality of completers.

7. The method of claim 1, further comprising:
scheduling, independently from the determination of whether to adjust, at least one request to the at least one completer of the plurality of completers.

8. The method of claim 1, further comprising:
analyzing, based on destination identifications (IDs) of the plurality of completers, request-handling capacities of the plurality of completers.

9. The method of claim 1, wherein determining whether to adjust, based on the request-handling capacity and the busyness value associated with the at least one completer of the plurality of completers, the request handling rate of the at least one completer of the plurality of completers further comprises:
determining whether to adjust, at a requestor, based on the request-handling capacity and the busyness value associated with the at least one completer of the plurality of completers, the request handling rate of the at least one completer of the plurality of completers.

10. The method of claim 1, wherein a total bandwidth capacity of a requestor that generates at least one request that is to be handled by the at least one completer of the plurality of completers is a sum of individual completer bandwidths associated with the requestor.

11. An apparatus for destination-based request throttling, the apparatus comprising:
a requestor comprising:
a request-handling capacity analysis circuit configured to analyze a request-handling capacity associated with at least one completer of a plurality of completers;
a busyness tracking circuit configured to determine a busyness value associated with the at least one completer of the plurality of completers; and
a comparison circuit configured to determine whether to adjust, based on the request-handling capacity and the busyness value associated with the at least one completer of the plurality of completers, a request handling rate of the at least one completer of the plurality of completers.

12. The apparatus of claim 11, wherein the busyness tracking circuit is further configured to analyze completer busy (CBusy) indications in CHI response packets as indications of the busyness value associated with the at least one completer of the plurality of completers.

13. The apparatus of claim 11, further comprising:
a threshold determination circuit configured to determine, based on at least one of request-handling capacities or busyness values associated with the plurality of completers, a threshold associated with each completer of the plurality of completers.

14. The apparatus of claim 11, wherein to determine whether to adjust, based on the request-handling capacity and the busyness value associated with the at least one completer of the plurality of completers, the request handling rate of the at least one completer of the plurality of completers, the comparison circuit is further configured to:
compare the busyness value associated with the at least one completer of the plurality of completers to a corresponding threshold associated with the at least one completer of the plurality of completers; and
determine whether to adjust, based on the request-handling capacity and the comparison of the busyness value associated with the at least one completer of the plurality of completers to the corresponding threshold associated with the at least one completer of the plurality of completers, the request handling rate of the at least one completer of the plurality of completers.

15. The apparatus of claim 11, wherein the request-handling capacity analysis circuit is further configured to analyze, based on destination identifications (IDs) of the plurality of completers, request-handling capacities of the plurality of completers.

16. The apparatus of claim 11, further comprising a request scheduling circuit configured to:
schedule, independently from the determination of whether to adjust, at least one request to the at least one completer of the plurality of completers.

17. The apparatus of claim 11, wherein a total bandwidth capacity of the requestor that generates at least one request that is to be handled by the at least one completer of the plurality of completers is a sum of individual completer bandwidths associated with the requestor.

18. An apparatus for destination-based request throttling, the apparatus comprising:
means for determining whether to adjust, based on a request-handling capacity and a busyness value associated with at least one completer of a plurality of completers, a request handling rate of the at least one completer of the plurality of completers.

19. A non-transitory computer-readable medium storing computer-executable instructions that, when executed by a processor, cause the processor to:
determine whether to adjust, based on a request-handling capacity and a busyness value associated with at least one completer of a plurality of completers, a request handling rate of the at least one completer of the plurality of completers.
